(19) United States
(12) Patent Application Publication
(10) Pub. No.: US 2007/0240397 A1
(43) Pub. Date: Oct. 18, 2007

(54) Cordierite honeycomb structure body, method of producing the cordierite honeycomb structure body, and talc for use in the method

(75) Inventor: Kentaro Makino, Kuwana-shi (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/713,670

(22) Filed: Mar. 5, 2007

(30) Foreign Application Priority Data
Mar. 30, 2006 (JP) 2006-094368

(51) Int. Cl. B01D 39/20

(52) U.S. Cl. 55/523; 264/631; 501/119; 501/154

(57) ABSTRACT

In a method of producing a cordierite honeycomb structure body, talc, kaolin, and alumina as prepared raw materials are mixed. The mixed raw materials are extruded and molded in an extrusion molding step. The obtained green body is cut into plural green bodies of a specified length. In a following drying step, the green body is dried and then fired in order to make the cordierite honeycomb structure body. In particular, the talc for use in the mixing step has IgLoss (Ignition Loss) within a range of 5.7 to 6.5 wt % which is obtained by firing at 1,000° C. for two hours.

### CROSS-REFERENCE TO RELATED APPLICATION

This application is related to and claims priority from Japanese Patent Application No. 2006-94368 filed on Mar. 30, 2006, the contents of which are hereby incorporated by reference.

### BACKGROUND OF THE INVENTION

1. Field of the Invention

The present invention relates to a cordierite honeycomb structure body, a method of producing the cordierite honeycomb structure body, and talc for use in the method. Such a cordierite honeycomb structure body is used as a catalyst carrier for purifying particulate matter (PM) or fine particles involved in exhaust gas discharged from an internal combustion engine such as a diesel engine mounted on vehicles.

2. Description of the Related Art

A ceramic carrier or supporter has been widely known and used as a catalyst carrier which carries or support a catalyst. The catalyst is capable of purifying particulate matter (PM) or fine particles involved in exhaust gas emitted by an internal combustion engine such as a diesel engine mounted on vehicles. Such a ceramic carrier is composed of a plurality of cells arranged in a honeycomb structure. Each cell is surrounded by cell walls (or porous partition walls). Catalyst is supported on the surfaces of those cell walls. The ceramic carrier is used as the catalyst carrier for purifying exhaust gas.

A cordierite honeycomb structure body made of cordierite having a superior thermal resistance has been widely known and available as the ceramic carrier. It is the demand for the cordierite honeycomb structure body to have following features and characteristics:

A low thermal expansion coefficient and a highly thermal shock resistance in order to suppress the generation of cracks in the cordierite honeycomb structure body by thermal stress applied; and a large pore diameter capable of supporting catalyst.

A conventional method of producing a cordierite honeycomb structure body controls a pore diameter and a thermal expansion coefficient in the cordierite honeycomb structure body by adjusting the mixture ratio of cordierite raw materials and a particle diameter (see Japanese patent laid open publication No. JP-2001-205082). However, because of difficulty in controlling the mixture ratio of the cordierite raw materials and in adjusting the particle diameter of the raw materials, there is a possibility of not obtaining optimum and specified mixture ratio and thermal expansion coefficient.

For this reason, it has been desirable to provide an improved cordierite honeycomb structure body and a method of producing such a cordierite honeycomb structure body, having a superior exhaust gas purifying performance, an expanded average pore diameter, and a reduced thermal expansion coefficient.

### SUMMARY OF THE INVENTION

It is an object of the present invention to provide an improved cordierite honeycomb structure body having superior characteristic such as an expanded average pore diameter and a reduced thermal expansion coefficient, and a method of producing the above cordierite honeycomb structure body, and further to provide talc for use in the above method as a raw material.

To achieve the above purposes, the present invention provides a method of producing a cordierite honeycomb structure body composed of a plurality of cells surrounded by cell walls (as porous partition walls) arranged in a honeycomb structure. The method has a mixing step, an extrusion molding step, a cutting step, a drying step, and a firing step. In the mixing step, raw materials such as talc, kaolin, and alumina are prepared. In particular, the talc has a specified higher Ignition Loss (IgLoss) within the range of 5.7% by weight of the entire composition to 6.5% by weight of the entire composition (hereinafter, the term “percentages by weight” will be referred to as “wt %” for short) obtained by firing talc raw ore at a temperature of 1,000° C. for two hours. Then, the talc, the kaolin, and the alumina are mixed, which are raw materials of cordierite composing the cordierite ceramic honeycomb structure body finally produced. In the extruding and molding step, the ceramic raw materials are extruded and molded so as to produce a honeycomb shaped green body. In the cutting step, the honeycomb shaped green body is cut into plural bodied of a specified length. In the drying step, the honeycomb shaped green body of the specified length is dried. In the firing step, the dried honeycomb shaped green body is fired and the cordierite honeycomb structure body is finally produced.

The method of producing the cordierite honeycomb structure body (hereinafter, referred also to as “the honeycomb structure body” for short) performs the preparing step, the mixing step, the extrusion molding step, the cutting step, the drying step, and the firing step in order. The mixing step mixes the raw materials such as talc, kaolin, and alumina. In particular, the talc has a specified highly Ignition Loss (IgLoss) within a range of 5.7 wt % to 6.5 wt %. That is, the method of producing the honeycomb structure body uses the talc having the specified higher IgLoss that is within the range of 5.7 wt % to 6.5 wt %. The use of such talc can provide the honeycomb structure body of a large average pore diameter and a reduced thermal expansion coefficient. The expansion of the average pore diameter and the reduction of the thermal expansion coefficient can increase the capability of supporting or carrying catalyst on the surfaces of the cell walls in the honeycomb structure body and also increase the thermal shock resistance thereof. The method according to the present invention can provide the honeycomb structure body with a superior exhaust gas purifying capability. By the way, LgLoss means the amount of reduced weight of the talc after the execution of the firing at a specified temperature for the time period until its constant weight. The average pore diameter means the average of diameters of pores formed in the honeycomb structure body.

As of now, we do not explain a detailed and accurate mechanism why the talc having IgLoss within the higher range of 5.7 wt % to 6.5 wt % can enlarge the average pore diameter and reduce the thermal expansion coefficient. We predict the following mechanism to achieve such features. The IgLoss of the talc expresses the amount of water involved in talc particles. This water is evaporated at a high temperature, for example, at approximate 1,000° C.

The high IgLoss value means a high amount of water in the talc. The step of firing the honeycomb green body promotes the decomposition of the talc (liquefaction of the talc). The chemical reaction between the talc and the other raw materials such as the kaolin and the alumina is thereby promoted. This can promote the crystallization for the cordierite and can generate the cordierite crystal of high purity without occurring the crystallization of materials other than the cordierite, namely, without occurring phasing. The pores are formed at the position of each talc particle during the firing step of the honeycomb green body by performing the decomposition and the reaction of the talc. That is, the pores can be formed efficiently by promoting the decomposition of the talc. According to the above mechanism, the cordierite honeycomb structure body is made of the cordierite of a high purity and a low thermal expansion coefficient when compared with a honeycomb structure body made of the cordierite crystal and other crystals which are different kinds from the cordierite crystal. The honeycomb structure body of the present invention has a large average pore diameter because of the formation of pores generated by promoting the decomposition of the talc.

In accordance with another aspect of the present invention, there is provided a method of producing a cordierite honeycomb structure body composed of a plurality of cells surrounded by cell walls (as porous partition walls) arranged in a honeycomb structure. The method has a mixing step, an extrusion molding step, a cutting step, a drying step, and a firing step. In the mixing step, raw materials such as talc, kaolin, and alumina are prepared. In particular, the talc has a wire abrasion of not less than 25 mg. Then, the mixing step mixes the talc, the kaolin, and the alumina, as raw materials of cordierite composing the cordierite ceramic honeycomb structure body finally produced. In the extruding and molding step, the ceramic raw material is extruded and molded so as to produce a honeycomb shaped green body. In the cutting step, the honeycomb shaped green body is cut to plural bodies of a specified length. In the drying step, the honeycomb shaped green body of the specified length is dried. In the firing step, the dried honeycomb shaped green body is fired and the cordierite honeycomb structure body is finally produced.

The method of producing the cordierite honeycomb structure body (hereinafter, referred to as “a honeycomb structure body” for short) performs the preparing step, the mixing step, the extrusion molding step, the cutting step, the drying step, and the firing step in order. In the mixing step, the raw materials such as talc, kaolin, and alumina are mixed. In particular, the talc has the wire abrasion within a specified range, that is, the range of not less than 25 mg, obtained by performing the wire abrasion test. The use of such talc can provide the honeycomb structure body of a large average pore diameter and a reduced thermal expansion coefficient. The expansion of the average pore diameter and the reduction of the thermal expansion coefficient can increase the capability of supporting or carrying catalyst on the surfaces of the cell walls in the honeycomb structure body and also increase the thermal shock resistance thereof. The method according to the present invention can provide the honeycomb structure body with a superior exhaust gas purifying capability.

The wire abrasion test for talc was performed by a slurry of water solution of 2 wt % of the talc, in which three wires were contacted to three points on a rolling ceramic roll (φ60 mm×60 mm) while dropping the slurry on each wire in order to measure the wire abrasion of the talc. The dropping amount of slurry is 2 liters/minutes and the wire applied-pressure weight to the ceramic roll was 750 g. A plastic wire (COS60 of 40 mm×180 mm, approximately 1.7 g produced by NIPPON FILCON CO., LTD) was used as the wire. After the test, the average wire abrasion was measured based on the reduced amount (mg) of the weight of each of the three wires by measuring the weight of each wire before and after the test. The particle diameter was measured by using a laser-type particle size analyzer.

Because of the use of the talc whose wire abrasion has the specified range described above in the method of the present invention, it is possible to realize the enlargement of the average pore diameter and the reduction of the thermal expansion coefficient of the honeycomb structure body. Although we do not know, as of now, and explain its detailed mechanism, we estimate it as follows.

The wire abrasion of the talc means the degree of crush of talc particles. Using the talc having the above specified range of the wire abrasion can suppress the generation of crush of talc particles when performing the mixing step and the extrusion molding step. It is thereby possible to form the honeycomb green body involving the talc particles of a large diameter size which are randomly oriented. The method of the present invention uses scaly talc powder as talc. The scaly talc powder is obtained by powdering talc raw ore. The scaly talc powder has highly-orientated talc particles. The firing step of firing the honeycomb green body made of the scaly talc powder generates the honeycomb structure body having the orientated cordierite crystals. Plural pores are formed at fine spaces formed in the honeycomb structure body during the firing step by decomposition and reaction of the ceramic raw materials, in particular, the talc. Because of suppressing the occurrence of crash of the talc particles, the pores of a large diameter are generated in the cordierite honeycomb structure body has.

For this reason described above, the cordierite honeycomb structure body according to the present invention has the highly-oriented cordierite crystals that enable the cordierite honeycomb structure body to reduce the thermal expansion coefficient when compared with another honeycomb structure body having low-oriented cordierite crystals. Further, the configuration of the cordierite honeycomb structure body of the present invention has a large average pore diameter because of the suppression of the degree of scaly of the talc particles.

In accordance with another aspect of the present invention, there is provided talc as a cordierite raw material to be used in a manufacture of a cordierite honeycomb structure body composed of plural cells surrounded by cell walls arranged in a honeycomb structure. The talc has Ignition Loss (IgLoss) within a range of 5.7 to 6.5 wt % obtained by firing at 1,000° C. for two hours.

The talc according to the present invention has IgLoss within a range of 5.7 to 6.5 wt % that is obtained by firing talc raw ore at 1,000° C. for two hours. The cordierite honeycomb structure body produced by using the talc has the features of a large average pore diameter and a reduced thermal expansion coefficient whose features have already been described above. The use of the talc according to the present invention can increase the catalyst carrier capability and the thermal shock resistance of the cordierite honeycomb structure body. As a result, those features can provide the cordierite honeycomb structure body of a superior exhaust gas purifying capability.

In accordance with another aspect of the present invention, there is provided talc as a cordierite raw material to be used in a manufacture of a cordierite honeycomb structure body composed of plural cells surrounded by cell walls arranged in a honeycomb structure. Talc has a wire abrasion of not less than 25 mg.

The cordierite honeycomb structure body produced by using the talc of the present invention has the features of a large average pore diameter and a reduced thermal expansion coefficient whose features have already been described above. The use of the talc according to the present invention can increase the catalyst carrier capability and the thermal shock resistance of the cordierite honeycomb structure body. As a result, those features can provide the cordierite honeycomb structure body of a superior exhaust gas purifying capability.

In accordance with another aspect of the present invention, there is provided a cordierite honeycomb structure body manufactured by the method according to the present invention.

As described above, the cordierite honeycomb structure body produced by using the talc of the present invention has the features of a large average pore diameter and a reduced thermal expansion coefficient described above. The use of the talc according to the present invention can increase the catalyst carrier capability and the thermal shock resistance of the cordierite honeycomb structure body. As a result, those features can provide the cordierite honeycomb structure body of a superior exhaust gas purifying capability.

If the LgLoss of the talc is less than 5.7 wt % in a cordierite honeycomb structure body, there is a possibility of being difficult to enlarge the average pore diameter and to reduce the thermal expansion coefficient of the cordierite honeycomb structure body.

If the LgLoss of the talc is more than 6.5 wt % in a cordierite honeycomb structure body, there is a possibility of reducing the strength of the cordierite honeycomb structure body because of increasing the pore diameter more than necessary. It is therefore preferred that the IgLoss of the talc is set to the value within the specified range of 6.0 wt % to 6.5 wt %.

It is further preferred to set the particle diameter of the talc to the value within a specified range of 13 μm to 33 μm.

If the particle diameter of the talc is less than 13 μm, there is a possibility of being difficult to enlarge the average pore diameter and to reduce the thermal expansion coefficient of the cordierite honeycomb structure body. On the other hand, when the particle diameter of the talc exceeds 33 μm, there is a possibility of reducing the strength of the cordierite honeycomb structure body because of increasing the pore diameter more than necessary. It is therefore preferred that the average particle diameter of the talc is set to the value within the specified range of 13 μm to 33 μm, in particular, within the further specified range of 28 μm to 33 μm.

Still further, if the wire abrasion of the talc is less than 25 mg, there is a possibility of becoming difficult to enlarge the average pore diameter and to reduce the thermal expansion coefficient of the cordierite honeycomb structure body. It is therefore preferred for the talc to have the wire abrasion of not less than 35 mg.

Still further, it is preferred that the talc involves CaO of not more than 0.3 wt % as impurity.

If the talc involves CaO of more than 0.3 wt % as impurity, other crystals in addition to the cordierite crystal are also generated, and there is thereby a possibility of generating the cordierite crystal of a high purity. This introduces the difficulty of the enlargement of the average pore diameter and the reduction of the thermal expansion coefficient of the cordierite honeycomb structure body.

It is furthermore preferred that the pore diameter in the cordierite honeycomb structure body is not less than 5 μm. This configuration can increase the catalyst carrier capability of the honeycomb structure body and provide the honeycomb structure body of an improved and superior exhaust gas purifying capability.

It is moreover preferred that the thermal expansion coefficient of the cordierite honeycomb structure body is not more than 0.5×10⁻⁶/° C. This configuration can enhance the thermal shock resistance of the cordierite honeycomb structure body and thereby suppress the occurrence of crack in the cordierite honeycomb structure body.

### BRIEF DESCRIPTION OF THE DRAWINGS

A preferred, non-limiting embodiment of the present invention will be described by way of example with reference to the accompanying drawings, in which:

FIG. 1 is a perspective view showing an entire configuration of a cordierite honeycomb structure body according to a first embodiment of the present invention;

FIG. 2 shows a relationship between an average pore diameter and a talc particle diameter per ignition loss (IgLoss) in cordierite honeycomb structure bodies of the first embodiment and comparative examples;

FIG. 3 shows a relationship between a thermal expansion coefficient and a talc particle diameter per ignition loss (IgLoss) in cordierite honeycomb structure bodies of the first embodiment and comparative examples;

FIG. 4 shows a relationship between an average pore diameter and a talc particle diameter per wire abrasion in cordierite honeycomb structure bodies of the first embodiment and comparative examples;

FIG. 5 shows a relationship between a thermal expansion coefficient and a talc particle diameter per wire abrasion in cordierite honeycomb structure bodies of the first embodiment and comparative examples; and

FIG. 6 is a flow chart of steps in the method of producing the cordierite honeycomb structure body according to the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

In the first embodiment, various types of cordierite honeycomb structure bodies were produced using talc of different Ignition Loss (IgLoss) in order to quantitatively measure and estimate the average pore diameter and thermal expansion of the cordierite honeycomb structure bodies of the present invention and comparison examples.

That is, four cordierite honeycomb structure bodies were prepared as samples E1 and E2 correspond to the present invention and as comparison samples C1 and C2 that do not correspond to the present invention.

The samples E1 and E2 were made of the talc of IgLoss of 6.0 percentages by weight and 6.5 percentages by weight of the entire composition, respectively (6.0 wt % and 6.5 wt %, hereinafter, the term “percentages by weight” will be referred to as “wt %” for short). The comparison samples C1 and C2 according to the related art were made of the talc of IgLoss of 5.0 wt % and 5.5 wt %, respectively.

Further, in the first embodiment, the cordierite honeycomb structure bodies of different particle diameters of: 10, 15, 20, 25, 30, and 35 μm were prepared per talc (namely, per above sample). All of the talc described above have CaO of 0.3 wt % or less as impurity.

The talc was dressed or selected from talc raw ore of a mine in order to have the above specified IgLoss and then ground up into a desired particle diameter. In the first embodiment, the raw ore was produced from Hai Cheng in China in order to obtain the specified IgLoss described above.

In the experiment, the IgLoss (wt %) of each talc was determined by the following manner. A desired amount of the talc was prepared and a weight (=A) before heating was measured. The talc powder of a desired amount was then heated at 1,000° C. for two hours. A weight (=B) of the talc after heating was measured. The IgLoss (wt %) of the talc was prepared based on the equation {(A−B)/A}×100. The particle diameter of the talc was measured by using a laser-type particle size analyzer.

### (Basic Configuration)

The basic configuration of the cordierite honeycomb structure body for use in the measurement of the first embodiment will now be explained.

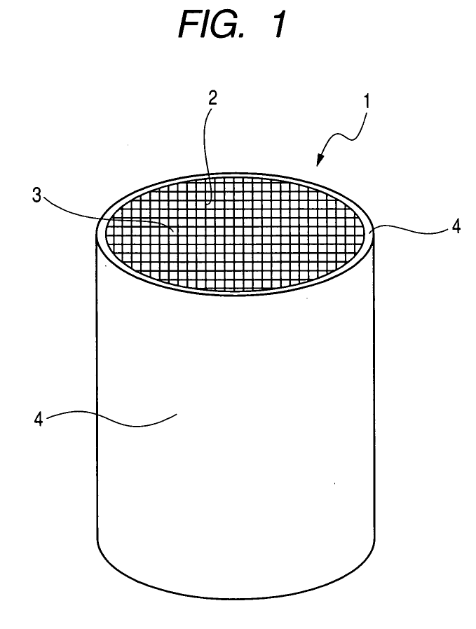

As shown in FIG. 1, the cordierite honeycomb structure body shown in the first embodiment is a honeycomb structure body made of cordierite ceramics for use in a catalyst carrier capable of purifying exhaust gas emitted by an internal combustion engine of a vehicle. In general, the honeycomb structure body 1 is composed of plural cells 3 of a square shape surrounded by cell walls (namely, porous partition walls) 2 and an outer peripheral wall 4 of a cylindrical shape surrounding the outer side wall of the honeycomb structure body 1. The outer diameter of the honeycomb structure body 1 is 50 mm, and the length thereof is 70 mm. The thickness of the honeycombs structure body 1 is 100 μm, and the thickness of the outer peripheral wall 4 is 500 μm.

### (Manufacturing Method)

Next, a description will be given of the manufacturing method of the cordierite honeycomb structure body according to the first embodiment of the present invention.

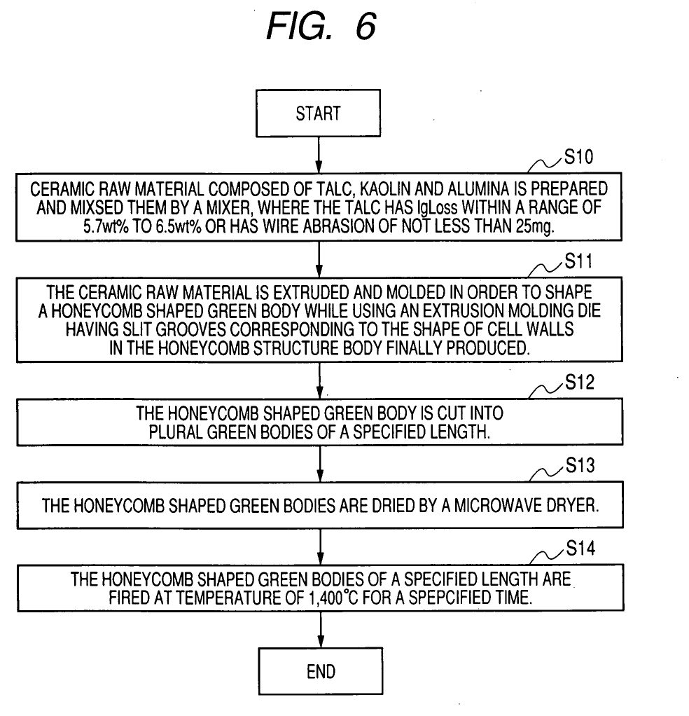

FIG. 6 is a flow chart showing the manufacturing method according to the present invention.

The method of producing the honeycomb structure body includes a mixing step S10, an extrusion and molding step S11, a cutting step S12, a drying step S13, and a firing step S14.

In the mixing step S10, talc, kaolin, and alumina as ceramic raw materials of the cordierite honeycomb structure body are mixed. In the extrusion and molding (namely, shaping) step S11, the ceramic raw materials are extruded and molded in order to produce a honeycomb shaped green body. In the cutting step S12, the honeycomb shaped green body is cut into a plurality of bodies of a desired length. In the drying step S13, those green bodies divided from the honeycomb shaped green body are dried. Finally, in the firing step S14, the divided green bodies are fired so as to produce the honeycomb structure bodies.

Next, the manufacturing method of the above steps S10 to S14 for producing the cordierite honeycomb structure body according to the first embodiment of the present invention will be explained in detail.

In the mixing step (step S10), the ceramic raw material are firstly produced. As the ceramic raw material, the ceramic raw powder involves talc of 38 to 40 wt %, kaolin of 46 to 48 wt %, and alumina of 12 to 16 wt % so that the ceramic raw powders finally include ceramic cordierite 2MgO.2Al₂O₃.5 SiO₂. Further, the ceramic raw material is produced by adding binder of 5 to 6 wt %, water of 20 to 25 wt %, lubricant of 2 to 2.5 wt % per the above ceramic raw powder of 100 wt %, and mixing them for 20 to 30 minutes by a mixer (a kneader) of 5 liters in volume.

Next, in the extrusion and molding step (step S11), the ceramic raw material is extruded and molded by using an extrusion molding die in order to shape the honeycomb shaped green body while using an extrusion molding die having slit grooves corresponding to the shape of the cell walls in the honeycomb structure body finally produced.

In the cutting step (step S12), the honeycomb shaped green body is cut into plural green bodies of a specified length. In the drying step (step S13), the honeycomb shaped green bodies are dried by a microwave dryer. In the firing step (step S14), the honeycomb shaped green bodies of a specified length are fired at the temperature of 1,400° C. for a specified time. The cordierite honeycomb structure body 1 is thereby produced.

### (Measurement Results)

Next, the average pore diameter and the thermal expansion coefficient were measured for samples E1 and E2 (present invention), C1 and C2 (comparison examples) of the cordierite honeycomb structure body obtained by the above manner.

The average pore diameter of the samples E1, E2, C1, and C2 were measured by using Mercury porosimeter and the thermal expansion coefficient thereof were measured in the temperature range of room temperature to 800° C. by using a thermal expansion coefficient measurement apparatus.

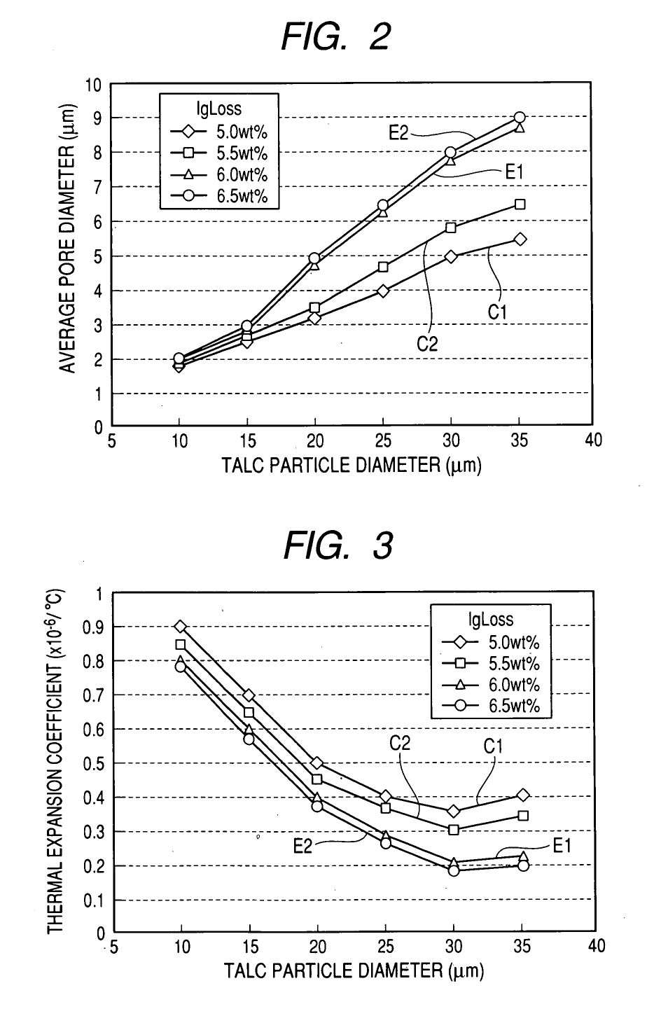

FIG. 2 and FIG. 3 show the measurement results of the average pore diameter and the thermal expansion coefficient per sample in the first embodiment. FIG. 2 shows the relationship between the average pore diameter and the talc particle diameter per IgLoss. In FIG. 2, the vertical line indicates the average pore diameter (μm), and the horizontal line indicates the talc particle size (μm).

As understood from FIG. 2, the average pore diameter of each of the samples E1 and E2 according to the present invention is greater than that of each of the comparison samples C1 and C2 of the related art. This means that the configuration of each of the samples E1 and E2 as the cordierite honeycomb structure body according to the present invention can enlarge the average pore diameter.

FIG. 3 shows the relationship between the thermal expansion coefficient and the talc particle diameter (or size) per IgLoss. In FIG. 2, the vertical line indicates the thermal expansion coefficient (×10⁻⁶/° C.), and the horizontal line indicates the talc particle size (μm).

As can be understood from FIG. 3, each of the samples E1 and E2 of the present invention has a smaller thermal expansion coefficient rather than that of each of the comparison samples C1 and C2 of the related art. This means that the configuration of each of the samples E1 and E2 as the cordierite honeycomb structure body of the present invention has the reduced thermal expansion coefficient.

According to the measurement results described above, the cordierite honeycomb structure body of the present invention can achieve both of the features of enlarging the average pore diameter and of reducing the thermal expansion coefficient by using the talc having IgLoss within a range of 6.0 wt % to 6.5 wt %.

It is further possible to obtain both of the features described above by using the talc having IgLoss within a range of 5.7 wt % to 6.5 wt %.

It is still further possible to remarkably obtain both of the features described above by using the talc having IgLoss within a range of 6.0 wt % to 6.5 wt %.

Although it is possible to slightly obtain the above effect of enlarging the average pore diameter when the talc particle size is 10 μm, it is possible to markedly obtain the effect of enlarging the average pore diameter when the talc particle size is approximately 15 μm (more precisely 13 μm). Although it is possible to obtain the effect of reducing the thermal expansion coefficient when the talc particle diameter (or size) is 30 μm from the measurement results shown in FIG. 3, the thermal expansion coefficient is slightly increased when the talc particle diameter (or size) is approximately 35 μm (more concretely, 33 μm).

Accordingly, it is preferred to take the talc particle size within a range of 13 to 33 μm in order to obtain both of the effects of enlarging the average pore diameter and of reducing the thermal expansion coefficient.

When the cordierite honeycomb structure body according to the present invention is applied to the catalyst carrier of purifying the exhaust gas emitted from an internal combustion engine mounted on vehicles, it is preferred to take the pore diameter (or size) of 5 μm or more in order to support the catalyst on the cordierite honeycomb structure body. It is still further preferred to have the thermal expansion coefficient of 0.5×10⁻⁶/° C. or less in order to adequately ensure the thermal impact resistance.

Accordingly, as can be understood from the measurement results shown in FIG. 2 and FIG. 3, it is preferred to take the talc particle diameter (or size) of 28 μm to 33 μm in order to satisfy the above-described conditions.

### Second Embodiment

In the second embodiment, like the manner for use in the first embodiment, various types of plural cordierite honeycomb structure bodies were produced using talc of different wire abrasions in order to quantitatively measure and estimate the average pore diameter and thermal expansion of the cordierite honeycomb structure bodies according to the present invention and related art.

In the second embodiment, two cordierite honeycomb structure bodies E3 and E4 were produced, as the present invention, by using the talc of different wire abrasions of 25 mg and 35 mg, and a cordierite honeycomb structure body C3 was also produced, as the related art, by using the talc of wire abrasions of 10 mg.

As described above, the talc used in the measurement according to the second embodiment have the wire abrasions of 10 mg, 25 mg, and 35 mg. The cordierite honeycomb structure bodies of different particle diameters 10, 15, 20, 25, 30, and 35 μm were further prepared per talc (or per above sample). All of the talc described above have CaO of 0.3 wt % or less as impurity.

Each talc was dressed or selected from raw ores of a mine in order to obtain the specified wire abrasions and then ground up into a desired particle diameter. In the second embodiment, like the first embodiment, the raw ores were produced from Hai Cheng in China in order to obtain the desired wire abrasions described above.

The talc was dressed or selected from raw ores of a mine in order to obtain such a desired wire abrasions and then ground up into a desired particle diameter. In the second embodiment, the raw ores were produced from Hai Cheng in China in order to obtain the desired wire abrasion described above.

The wire abrasion test for each talc was performed by a slurry of water solution of 2 wt % of the talc, in which three wires were contacted to three points on a rolling ceramic roll (φ60 mm×60 mm) while dropping the slurry on each wire in order to measure the wire abrasion of the talc. The dropping amount of the slurry is 2 liters/minutes and the wire applied-pressure weight to the ceramic roll was 750 g. A plastic wire (COS60 of 40 mm×180 mm, approximately 1.7 g produced by NIPPON FILCON CO., LTD) was used as the wire. After the test, the average wire abrasion was measured based on the reduced amount (mg) of the weight of each of the three wires by measuring the weight of each wire before and after the test. The particle diameter was measured by using a laser-type particle size analyzer.

The basic configuration (see FIG. 1) and the method of producing the cordierite honeycomb structure body in the second embodiment are same of those in the first embodiment. That is, the method of the second embodiment is performed based on the steps shown in FIG. 6, like the method of the first embodiment. In particular, the mixing step of the second embodiment uses the talc having a wire abrasion of not less than 25 mg.

In the measurement of the second embodiment, the average pore diameter and the thermal expansion coefficient of each of the samples E3, E4, and C3 of the cordierite honeycomb structure bodies were measured. The second embodiment used the same manner of measuring the average pore diameter and the thermal expansion coefficient of each sample used in the first embodiment.

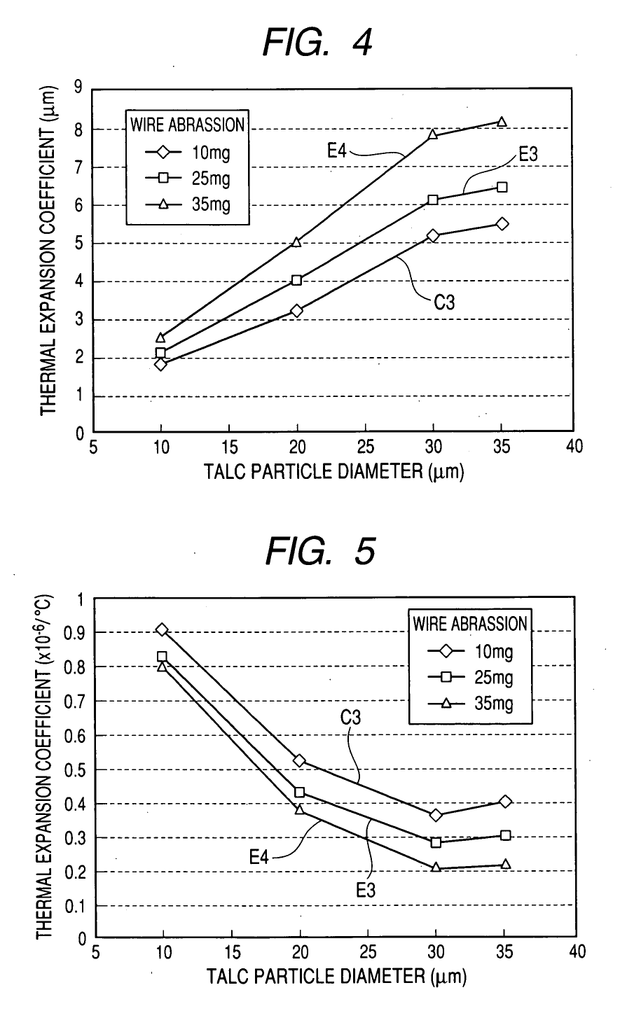

FIG. 4 and FIG. 5 show the measurement results of the average pore diameter and the thermal expansion coefficient per sample used in the second embodiment.

FIG. 4 shows the relationship between the average pore diameter and the talc particle diameter per wire abrasion. In FIG. 4, the vertical line indicates the average pore diameter (μm), and the horizontal line indicates the talc particle size (μm).

As can be understood from FIG. 4, the average pore diameter of each of the samples E3 and E4 according to the present invention is greater than that of the sample C3 according to the related art. This means that the configuration of each of the samples E3 and E4 as the cordierite honeycomb structure body according to the present invention can enlarge the average pore diameter.

FIG. 5 shows the relationship between the thermal expansion coefficient and the talc particle diameter (or size) per wire abrasion. In FIG. 5, the vertical line indicates the thermal expansion coefficient (×10⁻⁶/° C.), and the horizontal line indicates the talc particle size (μm).

As can be understood from FIG. 5, each of the samples E3 and E4 according to the present invention has a smaller thermal expansion coefficient rather than that of the comparison sample C3 of the related art. This means that the configuration of each of the samples E3 and E4 as the cordierite honeycomb structure body of the present invention can reduce the thermal expansion coefficient.

According to the measurement results described above, the cordierite honeycomb structure body of the present invention can achieve both of the features capable of enlarging the average pore diameter and reducing the thermal expansion coefficient by using the talc having wire abrasion of 25 mg and 35 mg.

It is further possible to obtain both of the features described above by using the talc having wire abrasion of not less than 25 mg.

It is still further possible to markedly obtain both of the features described above by using the talc having wire abrasion of not less than 35 mg.

Although it is possible to slightly obtain the above effect of enlarging the average pore diameter when the talc particle size is 10 μm, it is possible to markedly obtain the effect of enlarging the average pore diameter when the talc particle size is approximately 15 μm or more (more precisely 13 μm or more).

Although it is possible to obtain the effect of reducing the thermal expansion coefficient when the talc particle diameter (or size) is 30 μm from the measurement results shown in FIG. 5, the thermal expansion coefficient is slightly increased when the talc particle diameter (or size) is approximately 35 μm (more concretely, 33 μm).

Accordingly, it is preferred to take the talc particle size within the specified range of 13 to 33 μm in order to obtain both of the effects of enlarging the average pore diameter and reducing the thermal expansion coefficient.

When the cordierite honeycomb structure body according to the present invention is applied to the catalyst carrier capable of purifying the exhaust gas emitted by an internal combustion engine mounted on vehicles, it is preferred to take the pore diameter (or size) of 5 μm or more in order to support the catalyst on the cordierite honeycomb structure body. It is still further preferred to have the thermal expansion coefficient of 0.5×10⁻⁶/° C. or less in order to adequately ensure the thermal impact resistance.

Accordingly, as can be understood from the measurement results shown in FIG. 4 and FIG. 5, it is preferred to take the talc particle diameter (or size) of 28 μm to 33 μm in order to satisfy the above-described conditions.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A method of producing a cordierite honeycomb structure body composed of a plurality of cells surrounded by cell walls arranged in a honeycomb structure, comprising steps of:
mixing talc, kaolin, and alumina for producing a ceramic raw material as a cordierite, in which the talc has Ignition Loss (IgLoss) within a range of 5.7 wt % to 6.5 wt % obtained by firing at a temperature of 1,000° C. for two hours;
extruding and molding the ceramic raw material so as to produce a honeycomb shaped green body;
cutting the honeycomb shaped green body to plural bodies of a specified length;
drying the honeycomb shaped green body of the specified length; and
firing the dried honeycomb shaped green body in order to produce a honeycomb structure body.

2. The method of producing a cordierite honeycomb structure body according to claim 1, wherein the talc has IgLoss within a range of 6.0 wt % to 6.5 wt %.

3. The method of producing a cordierite honeycomb structure body according to claim 1, wherein the talc has an average particle diameter within a range of 13 μm to 33 μm.

4. The method of producing a cordierite honeycomb structure body according to claim 1, wherein the talc has an average particle diameter within a range of 28 μm to 33 μm.

5. A method of producing a cordierite honeycomb structure body composed of a plurality of cells surrounded by cell walls arranged in honeycomb structure, comprising steps of:
mixing talc, kaolin, and alumina for producing a ceramic raw material as a cordierite, in which the talc has a wire abrasion of not less than 25 mg;
extruding and molding the ceramic raw material so as to produce a honeycomb shaped green body;
cutting the honeycomb shaped green body to plural parts of a specified length;
drying the honeycomb shaped green body of the specified length; and
firing the dried honeycomb shaped green body in order to produce a honeycomb structure body.

6. The method of producing a cordierite honeycomb structure body according to claim 5, wherein the talc has the wire abrasion of not less than 35 mg.

7. The method of producing a cordierite honeycomb structure body according to claim 1, wherein the talc involves CaO of not more than 0.3 wt % as an impurity.

8. A talc as a cordierite raw material to be used in a manufacture of a cordierite honeycomb structure body composed of plural cells surrounded by cell walls arranged in a honeycomb structure, wherein the talc has Ignition Loss (IgLoss) within a range of 5.7 to 6.5 wt % obtained by firing at 1,000° C. for two hours.

9. The talc according to claim 8, wherein the talc has IgLoss of within a range of 6.0 wt % to 6.5 wt %.

10. The talc according to claim 8, wherein the talc has an average particle diameter within a range of 13 μm to 33 μm.

11. The talc according to claim 8, wherein the talc has an average particle diameter within a range of 28 μL m to 33 μm.

12. A talc as a cordierite raw material to be used in a manufacture of a cordierite honeycomb structure body composed of plural cells surrounded by cell walls arranged in a honeycomb structure, wherein the talc has a wire abrasion of not less than 25 mg.

13. The talc according to claim 12, wherein the talc has the wire abrasion of not less than 35 mg.

14. The talc according to claim 8, wherein the talc involves CaO of not more than 0.3 wt % as an impurity.

15. A cordierite honeycomb structure body manufactured by the method according to claim 1.

16. The cordierite honeycomb structure body according to claim 15, wherein the cordierite honeycomb structure body has an average pore diameter of not less than 5 μm.

17. The cordierite honeycomb structure body according to claim 15, wherein the cordierite honeycomb structure body has a thermal expansion coefficient of not more than 0.5×10⁻⁶/° C.

18. A cordierite honeycomb structure body manufactured by the method according to claim 5.

19. The cordierite honeycomb structure body according to claim 18, wherein the cordierite honeycomb structure body has an average pore diameter of not less than 5 μm.

20. The cordierite honeycomb structure body according to claim 18, wherein the cordierite honeycomb structure body has a thermal expansion coefficient of not more than 0.5×10⁻⁶/° C.
